(19) United States
(12) Patent Application Publication
(10) Pub. No.: US 2018/0002097 A1
(43) Pub. Date: Jan. 4, 2018

(54) Sustainable Paper Composites and Food Packaging Assemblies

(71) Applicants: Bradley Farrell, Burbank, CA (US); Jennifer Stitz, North Hollywood, CA (US); Cristi Stitz, Los Angeles, CA (US)

(72) Inventors: Bradley Farrell, Burbank, CA (US); Jennifer Stitz, North Hollywood, CA (US); Cristi Stitz, Los Angeles, CA (US)

(21) Appl. No.: 15/598,172

(22) Filed: May 17, 2017

Related U.S. Application Data
(63) Continuation of application No. 13/626,811, filed on Sep. 25, 2012.

(51) Int. Cl. B65D 81/26; F26B 5/16; F26B 9/00

(52) U.S. Cl. CPC B65D 81/264; F26B 9/003; F26B 5/16; B65D 2585/366

(57) ABSTRACT

A sustainable paper composite food packaging material includes an absorbent layer and a non-absorbent layer, the absorbent layer in one embodiment having an oleophilic surface and the non-absorbent layer having an oleophobic surface. The absorbent layer is physiologically safe for food contact applications, such as removing oil and grease from pizza and other cooked foods. Food packaging assemblies containing the sustainable paper composite material, for example, a pizza box assembly, and methods of using the composite material to blot oil and other liquids from food surfaces are also described herein. In one embodiment, the composite material is positioned beneath the pizza with the absorbent layer facing upwardly to contact the underside of the pizza in use.

### CROSS REFERENCE TO RELATED APPLICATION(S)

This application is a continuation of U.S. patent application Ser. No. 13/626,811, filed Sep. 5, 2012, and entitled “Disposable Pizza-Blotting Composite and Box”, the contents of which are expressly incorporated herein in their entirety.

### TECHNICAL FIELD

In general, the present disclosure relates to paper substrates. In particular, oil and grease-absorbing devices and methods are described herein.

### BACKGROUND

Many people enjoy “take-out” food as a convenient and economical meal, which has a wide array of options for satisfying individual tastes. Many take out foods for example, fries, pizza, nachoes, burritos, tacos, fried rice, stir fry, macaroni and cheese, pasta, fried noodles, fried chicken, hot dogs, burgers, bbq, popcorn, contain excess grease and are messy to eat. The oil, grease, and juices that saturate and drip from many take out entrees can a ruin clothing, upholstery, and the experience of eating.

Despite the mess, many types of take out are increasing in popularity, for example, pizza. Weather fresh or frozen the market for pizza has expanded in recent years, due in part to the introduction of gourmet toppings at a lower price point. In addition to the mess of pizza grease, the high amounts fat, cholesterol, and sodium are one of pizza's negative aspects. Accordingly, absorbent composite materials for removing excess nutrients present in the oily or greasy surface produced by cheese and meat toppings during pizza baking is needed to make pizza and other take out foods healthier.

In the past, some consumers have used napkins and other paper products to blot excess oil and grease from a pizza's surface before eating to reduce their fat consumption. This approach, however, is ineffective because the oil and grease bleeds through the napkin and transfers to the hands of the consumer, thus requiring the use of additional napkins. Integrating absorbent and OGR (oil and grease resistant) properties into durable food packaging is therefore needed to improve the experience and health effects of pizza and other take out foods.

A third problem with conventional pizza delivery boxes and other take out packaging is that oil and grease from pizza toppings (such as meat and cheese) and other take out foods tend to be absorbed by the packaging itself. Once oil has been absorbed into a paper product, cardboard box, or other packaging material the packaging is no longer recyclable and must be incinerated or placed in a landfill. As a result, unlike most glass, metal, plastic, and cardboard drink containers, the vast majority of food packaging is not recycled. An degradable paper composite and food packaging assembly for effectively removing excess nutrients from pizza and other take out foods without spoiling the packaging is therefore needed. This material and applications thereof would make eating take out food a cleaner more enjoyable experience, while removing excess nutrients and persevering the reusability of food packaging.

### SUMMARY OF INVENTION

An oil and grease-blotting composite according to the invention includes an absorbent layer and a non-absorbent layer, the absorbent layer having an oleophilic surface and the non-absorbent layer having an oleophobic or other suitable surface through which oil and grease cannot easily penetrate. The absorbent layer is low-linting and physiologically safe for food contact applications, such as removing oil and grease from pizza and other food items. The absorbent layer and the non-absorbent layer are joined to form a composite that may be dimensioned to cover all or a substantial portion of a pizza's surface. A pizza box assembly may also be provided with the oil and grease-blotting composite, in which the non-absorbent layer of the composite is secured to the interior top or bottom surface of the pizza box.

In one embodiment, the oil and grease-blotting composite is positioned against the bottom surface of a pizza box to absorb oil and grease from below, leaving the upper surface of the pizza undisturbed and appetizing. It has been found that positioning the composite below the pizza in this position, with the absorbent side up, is highly effective in extracting oil and grease from the pizza. Furthermore, the non-absorbent layer at the bottom of the composite substantially prevents oil and grease from reaching the cardboard of the box, preserving the ability of the box to be recycled after use. Alternatively, oil and grease blotting composite layers may be placed both above and below the pizza to extract oil and grease from both directions.

In a further embodiment, the non-absorbent layer may be an insulating oil and grease resistant paper or metallic foil that reflects heat back toward the pizza or other food item, thereby minimizing the dissipation of heat through the box.

More specifically, in an embodiment, the invention comprises a disposable food-blotting composite having an absorbent layer comprising a physiologically safe cellulosic fibrous mat material with at least one oleophilic surface; and a flexible, non-absorbent layer underlying the absorbent layer, the non-absorbent layer including a malleable polymeric material having at least one oleophobic surface; wherein the absorbent layer and the non-absorbent layer are joined to one another to form a composite and wherein the composite is dimensioned to cover a substantial portion of a surface of an item of food with the absorbent layer configured to contact the item of food in use.

Alternatively, a pizza box assembly according to the invention may include a pizza box having a top and an inner receptacle covered by the top; a pizza-blotting composite including an absorbent layer comprising a physiologically safe material having at least one oleophilic surface; a flexible, non-absorbent layer containing a malleable material having at least one oleophobic surface; and one or more flexible lamination layers or coatings having at least one oleophobic surface, the flexible lamination layer for covering at least one surface of the absorbent layer, the non-absorbent layer or both; wherein the absorbent layer, the non-absorbent layer, and the at least one lamination layer are joined to one another to form a composite and wherein the composite is dimensioned to cover a substantial portion of a surface of a pizza with the absorbent layer facing the pizza in use, and wherein the non-absorbent layer is attached to the bottom interior surface of the pizza box.

A method of the invention for extracting oil and grease from a food item after cooking involves i) obtaining a composite sheet having an absorbent layer of a physiologically safe material having at least one oleophilic surface; a flexible, non-absorbent layer underlying the absorbent layer, the non-absorbent layer including a malleable material having at least one oleophobic surface; and one or more flexible lamination layers or coatings having at least one oleophobic surface, the flexible lamination layer for covering at least one surface of the absorbent layer, the non-absorbent layer or both; wherein the absorbent layer, the non-absorbent layer, and the at least one lamination layer are joined to one another to form a composite and wherein the composite is dimensioned to cover a substantial portion of a surface of an item of food with the absorbent layer facing the item of food; ii) placing the composite sheet above, below, or both above and below the item of food after it is cooked; and iii) discarding the composite sheet after oil and grease from the food item have been absorbed by the absorbent layer.

The composite oil blotting composite paper may be configured to absorb grease from food, cooking oil, hydrocarbons, lubricants, or any other type of oil substance. The composite paper may also be configured to be recyclable, compostable, biodegradable, or otherwise configured for sustainable use. By combining the oil resistance necessary to prevent oil from spoiling otherwise recyclable food packaging with the disposal advantages of paper, for example, compostablily and biodegradably, the composite paper described herein offers a comprehensive and sustainable solution to cardboard spoilage.

### BRIEF DESCRIPTION OF THE DRAWINGS

A full and complete description of the present storage system is provided herein with reference to the appended figures, in which:

FIG. 1 is a top plan view of a pizza-blotting composite, according to a first aspect herein;

FIG. 2 is a cross-sectional view of the pizza-blotting composite of FIG. 1, as taken along line II-II of FIG. 1;

FIG. 3 is a perspective view of a pizza box assembly containing the pizza-blotting composite of FIG. 1, according to another aspect provided herein;

FIG. 4 is a perspective view, partially broken away, of a pizza box assembly containing the pizza-blotting composite of FIG. 1, according to yet another aspect provided herein; and

FIG. 5 is a perspective view, partially broken away, of a pouch-like container for storing the composite and distributing it to consumers with the purchase of a food item, such as pizza.

### DETAILED DESCRIPTION

Reference is now made to the drawings for illustration of various embodiments of the sustainable paper composite and food packaging assembly. While the discussions herein refer to a round composite configured to fit inside a pizza box assembly, it should be understood that the composite may be made in any shape, as needs dictate, for example, to accommodate rectangular pizzas or to cover the top or bottom of a square or rectangular pizza box. The sustainable paper composite may also be integrated into any type of food packaging, for example, bags, trays, boxes, plates and other dishes, wrappers, foils, or cartoons. Further, although the discussion herein focuses on absorbing oil from pizza surfaces, it should be understood that the composite described herein is equally well suited for absorbing oil and/or grease from other dishes, such as lasagna, fries, nachoes, burritos, tacos, fried rice, stir fry, macaroni and cheese, pasta, fried noodles, fried chicken, hot dogs, burgers, bbq, popcorn, and other messy foods.

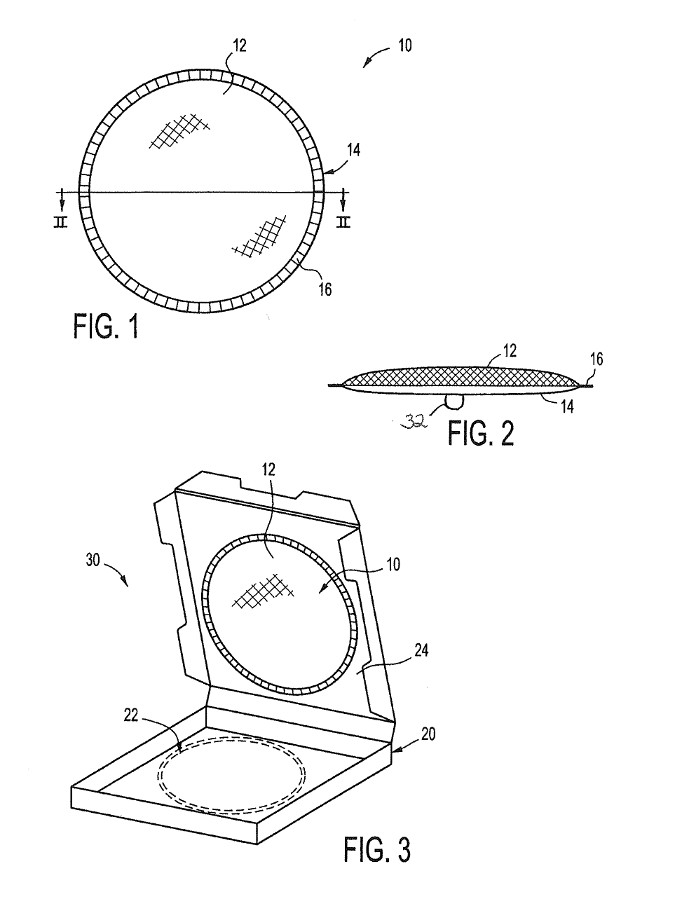

FIG. 1 is a pizza-blotting composite 10 having an absorbent layer 12 that is joined to a non-absorbent layer 14 (seen more clearly in FIG. 2). As illustrated, the composite 10 has a perimeter edge 16, which results from the joining of the absorbent layer 12, and the non-absorbent layer 14. The layers 12, 14 may be joined by any suitable means, including, but not limited to, and adhesive, film lamination, seaming, embossing, quilting, and surface bonding. In embodiments with lamination, a degradable lamination may be applied to at least one surface of the absorbent layer, non absorbent layer, or both. The lamination layer may be placed between the absorbent layer and non absorbent layer or added to an exterior surface of the absorbent layer or non absorbent layer. The composite 10 is dimensioned to cover a substantial portion of a surface of a pizza or other take out food and, accordingly, may be provided in a number of different sizes to accommodate foods of different sizes.

The absorbent layer 12 may be made of any suitable material that is capable of absorbing oil or grease in significant quantities. Such materials include, but are not limited to, bi-component micro-fibers, biodegradable fibers, and cellulosic fibers. Thus, the material of the absorbent layer 12 may include materials that are oleophilic, meaning that they have an affinity for oils and grease but not water. The absorbent layer 12 is physiologically safe for food contact applications and may be low-linting, such that the absorbent layer 12 does not leave lint on the food (e.g. pizza) after contact. In this example, the absorbent layer 12 is a grade of crepe paper comprising a nonwoven web or mat of fibrous material.

The non-absorbent layer 14 (seen in FIG. 2) may be made of any suitable non-absorbent material that is not permeable by oils or grease. Such materials include oil and grease resistant papers (OGR), oleophobic fiber webs, polymeric films and metallic coatings and foils (such as aluminum foil). Advantageously, when the non-absorbent layer 14 is made of a flexible OGR paper, the composite 10 may have a desirable degree of malleability, such that the composite may be crumpled after use for convenient disposal without the user having to contact the oil-soaked absorbent layer 12.

The lamination layer may be made of any degradable and compostable material capable of providing at barrier between the non absorbent or absorbent layers. Such materials include polymer films, clear plastics, and other degradable materials. When placed between an absorbent crepe paper and a the non absorbent OGR paper the lamination layer causes absorbed oils to wick across the surface of the absorbent layer. This wicking effect is produced by applying an impermeable, semi-permeable, or olephillic lamination layer to an absorbent layer with an uneven surface. In one example, the absorbent layer is a crepe paper with ridges and other small structures proliferating from the paper's surface to help wick absorbed liquid into the main portion of the paper.

The lamination layer can adhere to the structures on surface of the absorbent crepe paper and leave gaps between the main portion of the paper and the small structures. As oils are absorbed by the absorbent layer, an impermeable or semi-permeable lamination layer compresses the oils against the main portion of the absorbent layer and the lamination layer and driving the pool toward the wicking structures on the surface of the crepe. The wicking effect created by an absorbent layer with an uneven surface (with wicking structures) and an oleophobic lamination layer pulls the absorbed oil across the surface of the absorbent crepe in order to avoid pooling and oil seepage. By distributing oil more evenly across a greater portion of a food package the sustainable composite paper prevents absorbed oils from spoiling the reusability of food packaging while also making greasy foods healthier and less messy by removing excess nutrients.

In an exemplary embodiment, the absorbent layer 12 is a crepe paper comprising cellulosic fibers and the non-absorbent layer 14 is an OGR paper. More specifically, in one embodiment the absorbent layer 12 is a crepe paper made of four to six layers of cellulose wadding having a basis weight of 12 to 18 pounds. The material may be virgin material that is biodegradable and recyclable. The sheets of wadding may be “pinned” together initially in an embossing type process to form a friction connection that creates a self-supporting sheet of absorbent material. An example of such absorbent material is the cellulose sheeting sold by Pregis Corporation under the trademark “Cushion Pack”.

As described, the absorbent layer 12 is backed by the non-absorbent layer 14 and optionally coated by a lamination layer. The non-absorbent layer 14 may be a OGR paper or polymeric film, such as polyethylene, that is glued, attached by a lamination film, or otherwise affixed to the absorbent layer to form the composite 10. In one embodiment, the non-absorbent layer is laminated 10 to provide additional oil and grease resistance.

The sustainable composite paper may also disintegrate naturally and be biodegradable, non-toxic, and compostable under American Society for Testing and Materials (ASTM) or Biodegradable Products Institute (BPI) standards, for example the ASTM D6400 testing criteria for plastic and the ASTM D6868 testing criteria for coated paper products.

In use, the composite 10 is placed against a pizza or other food item from which oil or grease is to be blotted with the absorbent layer 12 in contact with the food item. The composite 10 may contact either an upper or lower surface of the food, as desired, to extract oil or grease without adversely affecting the food. In the case of pizza, which is commonly placed in a box for transportation, this leads to at least the following two potential positions of the composite 10 relative to the box.

FIG. 3 illustrates a pizza box assembly 30 that includes a pizza box 20 and the pizza-blotting composite 10 shown in FIGS. 1 and 2. The pizza box 20 is a standard collapsible box used commonly in the industry, having an inner cavity or receptacle 22 for holding the pizza and a top 24 of the box 20, such that the absorbent layer 12 faces the inner receptacle 22. The composite 10 may be attached to the interior top 24 of the box 20 by any suitable means, including adhesives. In one aspect, the composite 10 may be removed after use and the pizza box 20 may be recycled.

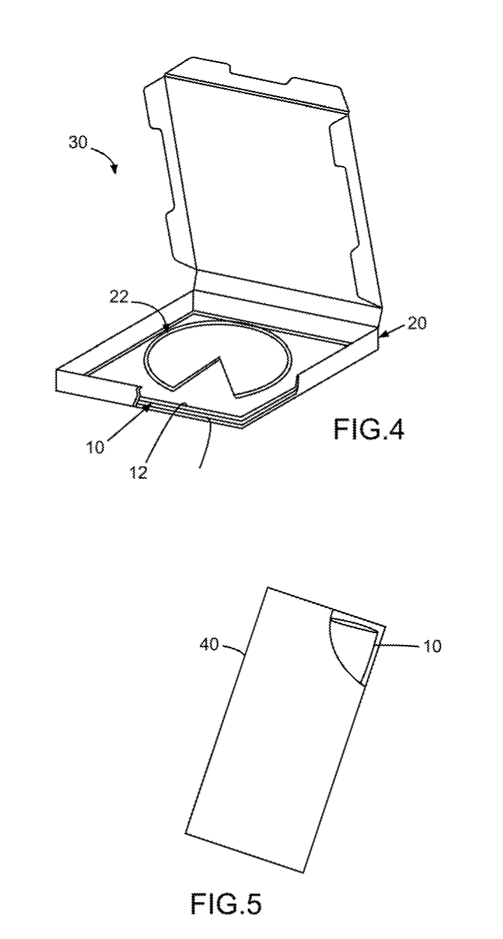

FIG. 4 illustrates an alternative arrangement of the composite 10 relative to the pizza box, wherein the composite is located within the inner receptacle 22 of the pizza box at a location beneath the pizza. When the pizza in the box is cut or “scored” oil and grease from the pizza is efficiently wicked to the underside by the absorbent layer 12 without disturbing the upper surface of the pizza as can occur when its upper surface is blotted. Therefore, the arrangement of FIG. 4 operates advantageously in a surprisingly efficient manner to extract undesired oil and grease.

When the composite 10 is used beneath the pizza in the configuration of FIG. 4, the pizza may be cut prior to or after being placed on the composite. Due to the durable nature of the composite, it is not normally severed when a rolling cutter is used on the pizza.

Placement of the composite beneath the pizza enables excess oil and grease to pass downwardly to the composite for efficient absorption by the absorbent layer 12. The oil and grease cannot pass beneath the composite 10, however, because the non-absorbent layer 14 acts as a barrier. The bottom of the pizza box 20 therefore remains oil and grease-free, enabling it to be recycled.

As illustrated in FIG. 4, the composite 10 may be square or any other suitable shape to cover the bottom of the pizza box. Particularly when the composite is placed beneath a pizza or other food item, it may be desirable to cover the entire bottom of the container in which the food item is placed. Alternatively, the composite 10 placed beneath a pizza may be circular and dimensioned to match the outline of the pizza.

In other instances, such as when pizza or other food items are consumed on the premises of a restaurant, the composite can still be used under the food to absorb the oil and grease. In any case, once the pizza is finished, the composite may be folded inwardly onto itself without touching the grease-saturated absorbent layer 12 by grasping the non-absorbent layer 14.

When the composite 10 is used to blot a pizza or other food item from above, the non-absorbent layer 14 may have a flexible tab, string, or other physical feature 32 enabling the user to lift the composite away from the food without touching the saturated absorbent layer 12. The weight of the absorbed oil and grease then causes the composite 10 to hang downwardly with the grease-impermeable non-absorbent layer 14 on the outside, facilitating disposal of the composite without getting oil or grease on the user's hands.

When the non-absorbent layer 14 is metallic, the composite 10 also serves an additional purpose of retaining heat within the pizza by reflection in either an up or down direction, depending on the position of the composite.

In another form, separate pieces of the composite 10 may be provided above and below a pizza with the absorbent layer 12 facing and in contact with the surfaces of the pizza to absorb oil and grease from both the top and the bottom of the pizza.

Alternatively, the top and bottom layers of the composite 10 may comprise a single sheet of the composite that extends underneath the pizza and is folded over to also engage the top of the pizza to absorb oil and grease from the top and bottom of the pizza simultaneously.

The foldable nature of the composite 10 enables it to be packaged in a compact and inexpensive package 40 which may be in the form of a sealed plastic, paper or foil-backed pouch, as illustrated in FIG. 5. In this form, the composite is suitable for distribution with a take-out pizza or other food item for convenient use by the consumer in extracting oil and grease from the food item. In situations where a composite 10 is provided above or below a pizza in the box of FIG. 3 or FIG. 4, another composite 10 might also be provided for manual use by the consumer to further reduce the quantity of oil and/or grease consumed.

The preceding discussion merely illustrates the principles of the present pizza-blotting composites and pizza box assemblies containing such pizza-blotting composites. It will thus be appreciated that those skilled in the art may be able to devise various arrangements, which, although not explicitly described or shown herein, embody the principles of the inventions and are included within their spirit and scope. Furthermore, all examples and conditional language recited herein are principally and expressly intended to be for educational purposes and to aid the reader in understanding the principles of the invention and the concepts contributed by the inventor to furthering the art and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. Terms such as “upper”, “top”, and “lower” are intended only to aid in the reader's understanding of the drawings and are not to be construed as limiting the invention being described to any particular orientation or configuration.

This description of the exemplary embodiments is intended to be read in connection with the figures of the accompanying drawings, which are to be considered part of the entire description of the invention. The foregoing description provides a teaching of the subject matter of the appended claims, including the best mode known at the time of filing, but is in no way intended to preclude foreseeable variations contemplated by those of skill in the art.

We claim:

1. A composite material comprising:
a paper surface having compostable, non-toxic absorbent and non-absorbent layers dimensioned to fit inside a pizza box assembly, the paper surface further dimensioned to cover the entire bottom surface of the pizza box assembly;
the absorbent layer comprised of one or more layers of biodegradable paper fibers, the outer layer of fibers having a textured surface, the absorbent layer for absorbing oil and grease from the underside of a pizza opposite the toppings and cheese; and
the non-absorbent layer applied to the back of the absorbent layer by film lamination, the non-absorbent layer comprising one or more layers of biodegradable polymeric film, the non-absorbent layer for trapping liquids in the absorbent layer in order to prevent liquids from bleeding through the non-absorbent layer;
the composite paper material for absorbing excess liquids from pizza when contacting at least one surface of the pizza with the absorbent layer, the composite paper material further for making the pizza box assembly recyclable by preventing grease absorbed from a pizza placed inside the pizza box assembly from contacting any surface of the pizza box assembly.

2. The composite of claim 1, wherein the absorbent layer comprises at least one of bi-component micro-fibers, biodegradable fibers, or cellulosic fibers.

3. The composite of claim 1, wherein the non-absorbent layer comprises a malleable polymer having at least one oleophobic surface.

4. The composite of claim 3, wherein the polymer is polyethylene.

5. The composite of claim 1, wherein the composite paper material is compostable.

6. The composite of claim 1, wherein the composite paper material disintegrates at least 90% in eighty-four days or more.

7. The composite of claim 4, wherein the composite paper material absorbs at least eight grams of oil from contacting the top and bottom surfaces of a pizza.

8. The composite of claim 1, wherein liquids absorbed by the composite paper material include at least one of water, oil, grease, trans fats, cholesterol, or fatty acid residues.

9. The composite of claim 1, wherein the paper surface is rounded to fit the shape of a circular pizza.

10. The composite of claim 1, wherein the paper surface is rectangular to fit the shape of a rectangular pizza box assembly.

11. A pizza box assembly comprising:
a collapsible rectangular box composed of cardboard, the rectangular box having an inner cavity for holding pizza;
a liner disposed in the inner cavity, the liner for absorbing excess fluids from pizza inserted into the box, the liner dimensioned to fit inside the pizza box assembly, the liner further dimensioned to cover an entire bottom surface of the pizza box assembly, the liner comprising:
a composite material having compostable, non-toxic absorbent and non-absorbent layers;
the absorbent layer comprising one or more layers of biodegradable paper fibers, the outer layer of fibers having a textured surface comprising bi-component micro-fibers, the absorbent layer for absorbing oil and grease from an underside of a pizza opposite toppings and cheese; and
the non-absorbent layer applied to the back of the absorbent layer by film lamination, the non-absorbent layer comprising one or more layers of polymeric film, the non-absorbent layer for trapping liquids in the absorbent layer so that the liquids do not bleed through the non-absorbent layer;
the composite material for absorbing excess liquids from pizza when contacting at least one surface of the pizza with the absorbent layer, the composite paper material further for making the pizza box assembly recyclable by preventing grease absorbed from a pizza placed inside the pizza box assembly from contacting any surface of the pizza box assembly.

12. The pizza box assembly of claim 11, wherein the liner is rectangular to fit a rectangular pizza box assembly.

13. The pizza box assembly of claim 12, wherein the liner is attached to the bottom surface of the rectangular box using an adhesive, the liner further positioned to contact at least one surface of the pizza with the absorbent layer.

14. The pizza box assembly of claim 11, wherein the liner is rounded to fit a circular pizza.

15. The pizza box assembly of claim 14, wherein the liner is attached to the top portion of the rectangular box using an adhesive, the liner is further positioned to contact a substantial portion of the top surface of the pizza with the absorbent layer by centering the liner in the top portion of the rectangular box and fixing the non-absorbent layer to the box.

16. The pizza box assembly of claim 11, wherein the liner is inwardly foldable and removable from the pizza box assembly.

17. The pizza box assembly of claim 14, wherein the rectangular box is recyclable after containing a pizza in the inner cavity, the rectangular box is made recyclable by folding the liner containing absorbed fluids inwardly onto itself to ensure only the non-absorbent layer contacts the rectangular box and removing the folded liner from the pizza box assembly.

18. The pizza box assembly of claim 15, wherein the liner further comprises a flexible lifting tab, the tab for providing a surface to grasp when the liner is folded or removed from the rectangular box.

19. A food packaging pouch comprising:
a sealable, rectangular receptacle having an inner cavity for disposing take out food, the receptacle composed of a compostable, non-toxic composite material, the composite material comprising:
an absorbent layer comprised of one or more layers of biodegradable paper fibers, the outer layer of fibers having a textured surface comprising bi-component micro-fibers, the absorbent layer for absorbing oil and grease from at least one surface of take out food; and
a non-absorbent layer applied to the back of the absorbent layer by film lamination, the non-absorbent layer comprising one or more layers of polymeric film, the non-absorbent layer for trapping liquids in the absorbent layer so that the liquids do not bleed through the non-absorbent layer;
the composite material for absorbing excess liquids from take out food when contacting at least one surface of take out food with the absorbent layer, the composite paper material further for making the food packaging pouch recyclable by preventing grease absorbed from a surface of take out food placed inside the food packaging pouch from contacting any surface of the pouch.

20. The pouch of claim 19, wherein take out food comprises at least one of fries, pizza, nachoes, burritos, tacos, fried rice, stir fry, macaroni and cheese, pasta, fried noodles, fried chicken, hot dogs, burgers, bbq meat, or popcorn.
